(19) United States
(12) Patent Application Publication
(10) Pub. No.: US 2007/0132129 A1
(43) Pub. Date: Jun. 14, 2007

(54) Process for producing silicon carbide ceramic

(75) Inventors: Tim Witzke, Neusass (DE); Bodo Benitsch, Buttenwiesen (DE)

Correspondence Address: LERNER GREENBERG STEMER LLP, P O BOX 2480, HOLLYWOOD, FL, 33022-2480, US

(73) Assignee: SGL Carbon AG

(21) Appl. No.: 11/636,742

(22) Filed: Dec. 11, 2006

(30) Foreign Application Priority Data
Dec. 9, 2005 (EP) 05 026 937.2

(51) Int. Cl. C01B 31/00; B28B 1/00

(52) U.S. Cl. 264/29.5; 264/682

(57) ABSTRACT

A process uses ground wood charcoal having a particle size of not more than 40 μm as a starting material for producing dense, compact, homogeneous and isotropic ceramic bodies containing a high content of silicon carbide and a geometric density of at least 2.80 g/cm³. A homogeneous mixture is formed from the ground wood charcoal and a carbonizable binder for forming the ceramic bodies.

### CROSS-REFERENCE TO RELATED APPLICATION

This application claims the priority, under 35 U.S.C. §119, of European application EP 05 026 937.2, filed Dec. 9, 2005; the prior application is herewith incorporated by reference in its entirety.

### BACKGROUND OF THE INVENTION

### Field of the Invention

The invention relates to a process for producing a ceramic containing silicon carbide.

It is known that ceramic bodies can be produced by silicization of carbon-containing precursor bodies. The carbon-containing precursor body can be obtained by pyrolysis of wood. This method is of economic interest because of the use of renewable raw materials. However, a disadvantage is that the pyrolysis of wood is associated with a high material shrinkage and that the original structure of the wood is retained within the pyrolyzed wood body and also within the ceramic body produced therefrom, so that an inhomogeneous ceramic which is anisotropic in terms of its structure and its properties is obtained.

To improve the homogeneity, the use of a pyrolyzable body containing wood in milled form has been proposed. Powder obtained by milling of wood (wood flour) is admixed with a binder and pressed to form a shaped body (green body). The shaped body containing a wood material which is obtained in this way is pyrolyzed and converted at least partly into silicon carbide ceramic by liquid silicization processes. The ceramic obtained in this way has a density of up to 3.07 g/cm³ and has an SiC content of up to 86.4% by volume (see the article by Hofenauer, A. et al., entitled: Development of Specific Wood-Based Composites as Precursors for Biomorphic SiC-Ceramics, Proc. of Materials Week 2002 in Munich; Deutsche Gesellschaft für Materialkunde, Frankfurt). Although comminution of the wood to produce wood flour improves the homogeneity and isotropy of the green body and the ceramic, this process, like that of starting out from an uncomminuted wood structure, does not allow near final shape manufacture since the volume shrinkage during pyrolysis of the green body is up to 65%.

Replacement of the starting material wood flour by ground wood charcoal reduces the problem of the volume shrinkage during pyrolysis without the use of renewable raw materials having to be abandoned. Wood charcoal is a mixture of organic compounds and generally contains carbon (81-90% by volume), hydrogen (3% by volume), oxygen (6% by volume), nitrogen (1% by volume), moisture (6% by volume) and ash (1-2% by volume). It is formed, for example, in the heating of air-dried wood (13-18% by volume of residual moisture) in an iron retort with exclusion of air at 275° C., with the internal temperature rising to 350-400° C. This process, which is known as wood carbonization or wood coking, gives a yield of about 35% by volume of wood charcoal as solid pyrolysis residue in additional to gaseous decomposition products.

However, thermogravimetric studies show that virtually complete pyrolysis of the starting material is achieved only at temperatures of about 900° C. Residual unpyrolyzed wood constituents are therefore still present in wood charcoal which has been obtained at temperatures of up to 400° C. It therefore requires further pyrolysis at temperatures up to 900° C. to rule out decomposition of the original wood building blocks still present. However, since the production of the wood charcoal has already involved a partial pyrolysis, it is to be expected that the volume shrinkage in the pyrolysis of wood charcoal will be less than in the pyrolysis of wood at the same maximum temperatures.

Published, non-prosecuted patent German application DE 31 08 266 A, corresponding to U.S. Pat. No. 4,564,496, discloses a process for producing porous silicon carbide bodies, in which wood charcoal, inter alia, can be used as starting material. The process includes the steps of:

a) pressing of a green body from carbon powder of a uniform sieve fraction, e.g. wood charcoal powder or plant charcoal powder, which has been admixed with a carbonizable binder, e.g. phenolic resin, pitch or tar;

b) heat treatment at a temperature of from 40 to 200° C. to drive off volatile constituents;

c) carbonization (pyrolysis) at 850° C. to give a porous “carbon body”; and

d) silicization using silicon vapor at a temperature of from 1,650 to 1,950° C.

To produce the precursor body, preference is given to using carbon powder of a sieve fraction of a few 100 μm, especially one of the following sieve fractions: 53-105 μm, 105-150 μm, 150-350 μm, 300-600 μm, 600-1,000 μm. The choice of the sieve fractions in published, non-prosecuted patent German application DE 31 08 266 was governed by the fact that the target product was a porous ceramic body which could be employed as a filter having a high throughput.

The content of the carbonizable binder in the green body is from 15 to 30% by mass, preferably 20% by mass. The density of the precursor body carbonized at 850° C. is in the range from 0.5 to 0.9 g/cm³, and the density of the silicized body is from 2.0 to 2.3 g/cm³. This relatively low density (the theoretical density of silicon carbide is 3.22 g/cm³) is a sign of the high porosity of the ceramic bodies obtained.

Published, non-prosecuted patent German application DE 31 08 266 teaches exclusively the production of porous bodies.

However, it is known that silicon carbide is an excellent construction material for the production of components which are subject to great mechanical or/and chemical or/and thermal stresses, e.g. bearings, pump impellers, components of chemical plants and the like. A dense material, i.e. a material having no open porosity, is of course required for this.

### SUMMARY OF THE INVENTION

It is accordingly an object of the invention to provide a process for producing silicon carbide ceramic which overcomes the above-mentioned disadvantages of the prior art methods of this general type. The invention provides a process starting out from wood charcoal as a starting material for producing dense (i.e. having no open porosity), compact, homogeneous and isotropic ceramic bodies having a high content of silicon carbide. This manifests itself in a high geometric density (ratio of the mass of the body to its geometric volume). Ceramic bodies formed of silicon carbide and having a geometric density of more than 2.80 g/cm³, preferably more than 2.95 g/cm³ and particularly preferably more than 3.00 g/cm³, can be produced by the process of the present invention.

The process of the invention includes the steps:

a) provision of ground wood charcoal whose particles have a particle size of not more than 40 μm;

b) production of a visually homogeneous mixture of the ground wood charcoal and a carbonizable binder;

c) production of a shaped body (green body) from this mixture;

d) carbonization (pyrolysis) of the green body at temperatures of about 900° C.;

e) optionally, after-densification of the carbonized green body by a carbonizable binder and renewed carbonization;

f) optionally, graphitization of the carbonized precursor body at temperatures of more than 1,400° C.; and

g) silicization of the carbonized green body by infiltration with a silicon melt.

Other features which are considered as characteristic for the invention are set forth in the appended claims.

Although the invention is described herein as embodied in a process for producing silicon carbide ceramic, it is nevertheless not intended to be limited to the details described, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments.

### DESCRIPTION OF THE PREFERRED EMBODIMENTS

As a starting material for the process of the invention, it is possible to use commercial barbecue wood charcoal. Preference is given to using wood charcoal certified in accordance with the standard DIN 51749. The wood charcoal should have a very low ash content. The above-mentioned DIN standard permits 4%, but a higher purity and thus a lower ash content can be necessary for particular applications.

The coarse particles having a size of several centimeters of the commercial wood charcoal are comminuted in a suitable manner, e.g. by use of a jaw crusher, and the desired fraction whose particle size should be not more than 40 μm is separated off by sieving. Depending on the nature of the starting material, comminution can comprise a number of stages, e.g. a first stage using a jaw crusher and a second stage using an impact mill.

To produce the green body, the ground wood charcoal is mixed with a carbonizable binder which is present either in solid form, i.e. as powder, or as a liquid. Suitable binders are phenol-formaldehyde resins, other resins which can be carbonized with a high carbon yield, e.g. furan resins, and all further binders known from the prior art for producing carbonizable green bodies, for example the binders pitch, tar, wax emulsions, sugar solutions, polyvinyl alcohol as proposed in the published, non-prosecuted patent German application DE 31 08 266 A.

The mixture should be as homogeneous as possible. When a liquid binder is used, care has to be taken to ensure that no conglomerates are formed. It has been found that particularly homogeneous mixtures can be obtained using pulverulent binders when the particle sizes of the binder powder and of the ground wood charcoal differ very little. The homogeneity of the mixture can be assessed by visual appearance when using, for example, a phenol-formaldehyde resin present in powder form as a binder thanks to the different color of the wood charcoal particles and the resin particles.

The binder content of the mixture is in the range from 15 to 50% by mass, preferably from 15 to 45% by mass, particularly preferably from 15 to 30% by mass.

A green body having dimensions close to the final shape is produced from the mixture containing ground wood charcoal and the binder by pressing, extrusion or by another shaping process. For example, the green body can also be produced by injection molding if the mixture of ground wood charcoal and binder is sufficiently flowable.

The temperature program employed in the shaping process has to be matched to the melting and curing behavior of the binder. For example, temperature programs having a first hold time at a temperature sufficient for melting the resin, a slow heating to a temperature sufficient for curing the resin and a longer hold time at this temperature are appropriate for phenol-formaldehyde resins as binders. The slow heating ensures that the exothermic curing process is not accelerated in an uncontrolled fashion.

The pyrolysis of the green body is carried out at about 900° C. under a nonoxidizing atmosphere, for example using nitrogen as protective gas. During the pyrolysis, wood constituents still present in the wood charcoal as a result of incomplete carbonization are degraded and the binder is thermally decomposed to leave a carbon residue. Owing to the degradation processes associated with the pyrolysis, mass and volume of the green body decrease, with the material shrinkage of the wood charcoal component being less than the material shrinkage of the binder because of the partial pyrolysis which has previously occurred in the production of the wood charcoal. The porosity of the pyrolyzed green body is therefore greater, the greater the binder content of the original green body. At a content of phenol-formaldehyde resin as the binder in the green body which is within the limits indicated above, carbonized precursor bodies having an open porosity of from 50 to 65% and a density of from 0.7 to 0.9 g/cm³ were obtained.

The improved dimensional accuracy in the carbonization resulting from the low material shrinkage of the wood charcoal compared to green bodies composed of other starting materials, in particular wood or wood materials, is a substantial advantage of the process of the invention.

The pyrolysis can of course also be carried out at temperatures higher than 900° C., but it has been found that precursor bodies produced at a pyrolysis temperature of about 900° C. give silicon carbide ceramics having the desired properties.

If desired, after-densification of the carbonized precursor body can be carried out by after-impregnating it with a carbonizable binder and then carbonizing it again. The carbon content of the carbonized precursor body can be increased in this way. The after-impregnation can be carried out using all binders which are also used in production of the green body, but liquid binders from this group are utilized for practical reasons.

The carbonized and, if desired, after-densified precursor body can, if necessary, be subjected to graphitization at temperatures of more than 1,400° C. in a nonoxidizing atmosphere. Appropriate processes and apparatuses are prior art.

For the silicization of the carbonized precursor bodies, infiltration with liquid silicon via wicks composed of carbon-containing material is preferred. In contrast to silicization by dipping or vapor silicization, in which the carbonized precursor body is confronted with an excess of silicon, the wicks allow silicon to be taken up by the carbonized precursor body in the amount consumed in the reaction with carbon to form silicon carbide. Dense (i.e. having no appreciable open porosity) ceramics having a high content of silicon carbide and a low proportion of excess, unreacted silicon can thus be obtained in this way.

The infiltration with a silicon melt is preferably carried out at temperatures of at least 1,420° C. under reduced pressure.

The geometric density of the silicized bodies is always more than 2.80 g/cm³ and is thus significantly above the density of the porous bodies whose production is known from DE 31 08 266. Silicized ceramic bodies having a geometric density of 3 g/cm³, for example, have been obtained from green bodies having a proportion of phenol-formaldehyde resin as the binder of at least 20% by mass. This value, which comes very close to the density of pure silicon carbide (3.22 g/cm³), is a sign of a high silicon carbide content of the ceramic and a low total porosity. Ceramic having a silicon carbide content of more than 85% by mass can be obtained by the process of the invention. The balance of the mass is made up of unreacted carbon or/and silicon and ash constituents.

A critical factor for achieving a high conversion of carbon and thus a high proportion of silicon carbide and homogeneous silicization in the ceramic is the accessibility of the carbon to infiltrated silicon. It has been found that precursor bodies which have been produced according to the present invention, i.e. from ground wood charcoal having a particle size of not more than 40 μm and a binder content of from 15 to 50% by mass, preferably up to a maximum of 30% by mass, have a porous system which favors substantial accessibility of the carbon and thus homogeneous silicization.

A further advantage of the inventive process starting out from ground wood charcoal having a very small particle size compared to the process of the prior art is that virtually no fragments of wood structures can be found in the ceramic by scanning electron microscopy. Comparative studies on ceramics which have been produced from ground wood charcoal having a particle size up to 250 μm under otherwise identical process conditions have, in contrast, a significantly more inhomogeneous microstructure in which residues of the original wood structure can be recognized by scanning electron microscopy.

The silicon carbide ceramic produced by the process of the invention is, owing to its inexpensive manufacture from renewable raw materials, an economically interesting replacement for SiC and SiSiC materials which have been produced by a conventional route and are used, in particular, for the production of components which are subject to high mechanical or/and chemical or/and thermal stresses.

Thanks to the dimensional accuracy in the high-temperature processes (carbonization, optionally graphitization, silicization) and the simple processibility and workability in the preceramic material stages, new fields of application which require relatively large, complex structures are also open to the ceramics produced by the process of the invention. Examples of applications are, inter alia, mirror holders, pipes, elbows and other structural elements for heat exchangers, as combustion chamber lining, ballistic protection facilities, wear protection layers in furnace construction and structural elements for the construction of chemical apparatus.

Such complex structural elements or components can, for example, be realized by joining components having simple geometries in the preceramized state, i.e. as green bodies or as carbonized precursor bodies, to one another by joining processes. A paste of ground wood charcoal and carbonizable binder is preferably applied as bonding agent at the joints. The assembled composite is then carbonized and silicized in its entirety by the process of the invention. Here, the paste applied at the joints is also converted into ceramic containing silicon carbide.

Complex structures whose individual components all formed of the same type of ceramic and are joined to one another at their joints by ceramic of the same type are obtained in this way.

If the composite produced from carbonized precursor bodies does not have extended joint areas which make application of the bonding agent over a large area necessary, the assembled composite can also be silicized directly without further carbonization. Carbonization of the binder present in the bonding agent then occurs during silicization.

We claim:

1. A process for producing ceramic containing silicon carbide and having a geometric density of at least 2.80 g/cm³, which comprises the steps of:
providing ground wood charcoal having particles with a particle size of not more than 40 μm;
producing a homogeneous mixture formed from the ground wood charcoal and a carbonizable binder;
producing a shaped body being a green body from the homegeneous mixture;
carbonizing the green body to form a carbonized precursor body at a temperature of at least 900° C. in a nonoxidizing atmosphere; and
silicizing the carbonized precursor body by infiltration with a silicon melt.

2. The process according to claim 1, which further comprises:
producing complex structural elements or components by joining a plurality of green bodies or a plurality of carbonized precursor bodies to form an assembled composite having a desired geometry, with a bonding agent being applied at joints; and
carbonizing and silicizing the assembled composite in its entirety.

3. The process according to claim 1, which further comprises:
producing complex structural elements or components by joining a plurality of carbonized precursor bodies to form a composite having a desired geometry, with a bonding agent being applied at joints; and
silicizing the composite in its entirety.

4. The process according to claim 1, which further comprises setting a proportion of the carbonizable binder in the homogeneous mixture of the ground wood charcoal and the carbonizable binder to be in a range of 15 to 50% by mass.

5. The process according to claim 1, which further comprises setting an ash content of the ground wood charcoal to be less than or equal to 4% by mass.

6. The process according to claim 1, which further comprises producing the green body by one of injection molding and extrusion.

7. The process according to claim 2, which further comprises after-impregnating one of the carbonized precursor body and the assembled composite after carbonization with a further carbonizable binder and then carbonizing it again at a temperature of at least 900° C.

8. The process according to claim 1, which further comprises selecting the carbonizable binder from the group consisting of phenol-formaldehyde resins, carbonizable resins having a high carbon yield, furan resins, pitch, tar, wax emulsions, sugar solutions, and polyvinyl alcohols.

9. The process according to claim 7, which further comprises subjecting the carbonized precursor body or the after-impregnated and then recarbonized precursor body to graphitization at temperatures of more than 1,400° C. in a nonoxidizing atmosphere.

10. The process according to claim 1, which further comprises carrying out the infiltration of the silicon melt at a temperature of at least 1,420° C. under reduced pressure.

11. The process according to claim 1, which further comprises setting a silicon content of the ceramic to be at least 85% by mass, with a balance of the mass being made up of unreacted carbon or/and silicon and ash constituents.

12. The process according to claim 1, which further comprises setting the geometric density of the ceramic containing the silicon carbide to be greater than 2.95 g/cm³.

13. The process according to claim 2, which further comprises providing a paste of ground wood charcoal and the carbonizable binder as the bonding agent.

14. The process as claimed in claim 3, which further comprises providing a paste of ground wood charcoal and the carbonizable binder as the bonding agent.

15. The process according to claim 1, which further comprises setting a proportion of the carbonizable binder in the homogeneous mixture of the ground wood charcoal and the carbonizable binder to be in the range of 15 to 30% by mass.

16. The process according to claim 1, which further comprises setting the geometric density of the ceramic containing the silicon carbide to be greater than 3.00 g/cm³.

17. The process according to claim 1, which further comprises after-impregnating the carbonized precursor body after carbonization with a further carbonizable binder and then carbonizing it again at a temperature of at least 900° C.

18. The process according to claim 1, which further comprises subjecting the carbonized precursor body to graphitization at temperatures of more than 1,400° C. in a nonoxidizing atmosphere.

19. The process according to claim 2, which further comprises subjecting the carbonized precursor body to graphitization at temperatures of more than 1,400° C. in a nonoxidizing atmosphere.

20. A process for producing a component containing a ceramic formed of silicon carbide and the ceramic having a geometric density of at least 2.80 g/cm³, which comprises the steps of:
providing ground wood charcoal having particles with a particle size of not more than 40 μm;
producing a homogeneous mixture formed from the ground wood charcoal and a carbonizable binder;
producing shaped bodies being green bodies from the homegeneous mixture;
carbonizing the green bodies to form carbonized precursor bodies at a temperature of at least 900° C. in a nonoxidizing atmosphere;
silicizing the carbonized precursor bodies by infiltration with a silicon melt;
producing a complex structural element by joining a plurality of the green bodies or a plurality of the carbonized precursor bodies to form an assembled composite having a desired geometry, with a bonding agent being applied at joints, the assembled composite being selected from the group consisting of mirror holders, parts for ballistic protection facilities, parts for heat exchangers, parts for furnaces, combustion chamber linings and parts for chemical apparatuses; and
carbonizing and silicizing the assembled composite in its entirety.
